(19) United States
(12) Patent Application Publication
(10) Pub. No.: US 2023/0063848 A1
(43) Pub. Date: Mar. 2, 2023

(54) MAGNETIC DOOR LATCH AND LOCK MECHANISMS

(71) Applicant: Illinois Tool Works Inc., Glenview, IL (US)

(72) Inventors: Dean Beardmore, Sydney (AU); Bryan Marshall, Sydney (AU); Zac Hanna, Sydney (AU)

(21) Appl. No.: 17/894,408

(22) Filed: Aug. 24, 2022

(30) Foreign Application Priority Data
Aug. 24, 2021 (AU) 2021221527

(51) Int. Cl. E05C 19/16; E05C 19/04

(52) U.S. Cl. CPC E05C 19/163; E05C 19/04

(57) ABSTRACT

In a door latch for a hinged or pivoting door having a latch fixture mounted in or on the door that supports a slideable bolt that is magnetically attracted to a fixed strike so as to effect latching action by extension of the bolt, a safety catch mechanism which, while engaged, prevents the bolt from extending, the safety catch mechanism having a catch member that operatively acts between the moveable bolt and the latch fixture, and an operating mechanism to operate the catch member responsive to magnetic forces from the strike. First and second actuators are disposed to opposite sides of the door, each of the first and second actuators being coupled to the latching mechanism to effect withdrawal of the latch bolt from its extended position to its retracted position upon operation by a user. A privacy lock mechanism is operable from one side of the door only and can be used to prevent the actuator on the other side of the door from operating the latch.

### PRIORITY CLAIM

The present application claims priority to and the benefit of Australian Patent Application No. 2021221527, filed Aug. 24, 2021, the entire contents of which are incorporated herein by reference.

### FIELD

The present disclosure relates to door latch and lock mechanisms having a magnetically operated bolt action. In one aspect of the present disclosure, a mechanism is provided to prevent inadvertent extension of the bolt. In one aspect of the present disclosure, a privacy engagement mechanism is provided.

### BACKGROUND

A door latch assembly conventionally includes a spring-biased latch head that projects from the edge of a hinge-mounted door which is arranged to engage a strike plate in a corresponding door frame. The latch head is typically disengaged (retracted) by way of the user turning or twisting a doorknob or handle to actuate the latch mechanism and manually retract the latch head, allowing the door to open. A characteristic of spring-biased moving latches is that the latch head is always resiliently biased to its extended position whether the door is open or closed.

The latch head in a magnetically operated door latch is intended to remain retracted while the door is open, with the latch head being drawn out into its extended configuration by magnetic forces when it aligns with the strike plate aperture in the door frame. This operating principle avoids certain difficulties that may be associated with an ordinary spring-biased latch, and also has other benefits, such as: (1) improved safety and aesthetics since the latch bolt remains retracted while the door is open and the strike plate does not require a protruding lip; (2) relatively quiet operation since the latch head is not required to impact the strike plate; and (3) the door latch may be equally used on doors that open in either direction, or on doors that swing in both directions.

Following action of the door closing, a magnet in the bolt head (which is nominally retracted into the door whilst the door is open) is drawn towards and captured in the strike plate cavity. For reliable operation of the magnetic door latch, the magnetic attraction should result in a strong positive action by being sufficiently powerful to easily overcome any frictional and/or opposite bias forces on the bolt head. Accordingly, frictional and/or opposite bias forces on the bolt head must be significantly less than the door-aligned magnetic forces. However, there may be circumstances of use or misuse of the door that could result in the bolt prematurely extending before the door is closed and the bolt is aligned with the strike plate cavity. For example, a door may be swung with force from a fully open configuration, whether by deliberate action or something like wind action on the door. Centrifugal forces generated by the rapidly pivoting door, having the magnetic latch at its leading edge, may be great enough to overcome the frictional and/or opposite bias forces on the bolt head, causing the bolt to extend from the edge of the door without application of magnetic forces and before the door is fully closed. If this were to happen, damage to the latch, door and/or door jamb could result.

There are further challenges involved in applying the principles of a magnetic door latch and/or a push/pull user actuation system to reliably implement a privacy locking function.

### SUMMARY

In accordance with one aspect of the present disclosure, in a door latch for a hinged or pivoting door having a latch fixture mounted in or on the door that supports a slideable bolt that is magnetically attracted to a fixed strike so as to effect latching action by extension of the bolt, a safety catch mechanism is provided which, while engaged, prevents the bolt from extending, the safety catch mechanism having a catch member that operatively acts between the moveable bolt and the latch fixture, and an operating mechanism to operate the catch member responsive to magnetic forces from the strike.

In various embodiments, the catch member is displaceable from a disengaged position to an engaged position in which the catch member binds together the bolt and latch fixture against relative longitudinal movement. The catch member may, for example, take the form of a ball made from non-magnetic material.

The operating mechanism may include a catch actuator having a magnetic component, the catch actuator being longitudinally displaceable within the bolt between engaged and disengaged positions while being spring biased toward the engaged position, wherein the catch actuator in its engaged position is arranged to hold the catch member in its respective engaged position.

In various embodiments, the catch actuator is displaceable by magnetic attraction with the strike from its engaged position to its disengaged position, thereby releasing the catch member from engagement.

In one embodiment, the catch member comprises a locking ball that is carried by the bolt and the latch actuator has a lifting surface that operatively lifts the locking ball into the engaged position.

According to one embodiment of the present disclosure, a latch mechanism for a hinged or pivoting door is provided and includes: a housing adapted for mounting in or on a door; a latch slider supported by the housing for reciprocating movement between an extended positon and a retracted position; at least one user operable actuator capable of driving the latch slider from the extended position to the retracted position; a latch bolt supported by the housing for reciprocating movement between an extended positon and a retracted position and coupled to the latch slider, the latch bolt including a bolt head having a magnetic component, wherein the latch bolt is operatively drawn to its extended position by magnetic force when the bolt head in use aligns with a magnetically susceptible strike member mounted on a corresponding door fixture; and a safety catch mechanism which, while engaged, prevents the bolt from extending, the safety catch mechanism having a catch member that operatively acts between the moveable bolt and the housing, and an operating mechanism to operate the catch member responsive to magnetic forces from the strike.

According to another embodiment of the present disclosure, there is also provided a door latch for a hinged or pivoting door, including a latch body mounted in or on the door and supporting a latching mechanism with a slideable bolt that is magnetically attracted to a fixed strike so as to effect latching action by extension of the bolt, the door latch further including: a latch slider assembly coupled to move with the latch bolt; first and second actuators disposed to opposite sides of the door, each of the first and second actuators having a lever arm arranged to act upon the latch slider assembly to effect withdrawal of the latch bolt from its extended position to a retracted position upon operation by a user; wherein the latch slider assembly includes a bolt carriage and a tab shuttle that is mounted for movement with the bolt carriage but arranged to permit relative displacement against a spring bias, and wherein the first lever arm is arranged to act upon a surface of the tab shuttle and the second lever arm is arranged to act upon a surface of the bolt carriage; and further including an entry lock mode mechanism having a privacy engagement member moveable between a first position and a second position, wherein the privacy engagement member when in the second position engages with the bolt carriage to prevent displacement of the latch slider assembly by the second actuator.

In various embodiments, the entry lock mode selection mechanism may include a user operable privacy pin located with the first actuator and coupled to the privacy engagement member to enable movement of the privacy engagement member between the first and second positions.

In various embodiments, the carriage shuttle has a latching action with the privacy engagement member to hold the privacy engagement member in the second position. The latching action of the carriage shuttle on the privacy engagement member may be released by operation of the first actuator lever arm on the tab shuttle.

Further aspects, features and advantages of the present disclosure will be apparent to those of ordinary skill in the art from the accompanying description and drawings.

### BRIEF DESCRIPTION OF THE DRAWINGS

In order that the present disclosure may be more easily understood, the following detailed description of a particular embodiment is provided, presented by way of example only and with reference to the accompanying drawings in which:

FIG. 1 is an exploded perspective view of components of a magnetic door latch and lock set according to one example embodiment of the present disclosure;

FIG. 2 is an exploded perspective view of the magnetic door latch bolt and components associated with a bolt extension safety catch mechanism;

FIG. 3 is a central vertical longitudinal section of the forward portion of the magnetic door latch in assembled condition showing the bolt safety catch mechanism in an engaged configuration;

FIG. 4 is a central vertical longitudinal section of the forward portion of the magnetic door latch aligned with the strike, to illustrate the process of disengaging the bolt safety catch mechanism;

FIG. 5 is a central vertical longitudinal section of the forward portion of the magnetic door latch with the bolt safety catch disengaged and the bolt seated in the strike cavity;

FIGS. 6, 7, and 8 are overhead perspective views of the latch and lock set with inside and outside handle assemblies (actuators), seen in central horizontal section to illustrate engagement of the privacy lock mechanism; and

FIG. 9 shows an enlarged section of FIG. 8.

### DETAILED DESCRIPTION

While the features, devices, and apparatus described herein may be embodied in various forms, the drawings show, and the specification describe certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, attached, connected, and the like, are not intended to be limited to direct mounting methods but should be interpreted broadly to include indirect and operably mounted, attached, connected and like mounting methods. This specification is intended to be taken as a whole and interpreted in accordance with the principles of the present disclosure and as understood by one of ordinary skill in the art.

Embodiments of the present disclosure as applied to a particular magnetic door latch are illustrated in the accompanying drawings and described herein. The general structure and functioning of a known magnetic door latch are shown and described in detail in the specification of Australian patent application AU2019226304, the contents of which are incorporated herein by reference. There are of course notable differences between the magnetic door latch described in this document and the door latch, which is the subject of AU2019226304, for example the mechanisms representing embodiments of the present disclosure(s). For ease of reference, where features/components described and illustrated in this document have the same or analogous function and/or purpose as features/components in AU2019226304, the same respective reference numerals have been used.

A magnetic door latch according to various embodiments described herein provide a feature-rich door latch and lock set capable of several distinct modes of operation, such as a passage mode, an entry lock mode, and a security lock mode. The resulting magnetic latch and lock set can thus be used in a wide variety of applications, including external doors where security against unwanted entry to a room or building is of concern.

The passage mode, as conventionally understood, enables the door to which the latch and lock set is fitted to be opened from either side by way of user operable actuators (e.g., door handles or the like). In the described embodiment the user operable actuators are in the form of push/pull handles.

The entry lock mode permits the latch and lock set to be configured so that the door can only be opened by way of the user operable actuator from one side (e.g., the ‘inside’). This is akin to a conventional ‘privacy mode’ although with a small but important difference. Conventionally a latch with a privacy mode has provision for the privacy mode to be disengaged from the ‘outside’ by inserting a pin or tool into a small aperture provided in the outside faceplate. However, this is undesirable for an external/entry door where unauthorized access is of concern. Accordingly, the entry lock mode as the term is used herein refers to the ability of the latch to be configured for free operation from the inside but only by way of a key from the outside. Nevertheless, the term ‘privacy’ may be used herein when referring to the function of the entry lock mode for convenience of nomenclature, bearing in mind the function may not be identical with conventional understanding.

The security lock mode corresponds to the function of a deadbolt, wherein operation of the latch to open the door is only possible using a key, from both the inside and the outside. Moreover, a key is required to engage the security lock mode, at least from the outside. For safety considerations, it is possible to provide a turn-snib in place of a key-operated lock on the inside of the door.

On a note of terminology, features of the door latch assembly, mechanisms and components may be described herein using reference to relative orientations or directions such as left/right, upper/lower, forward/back, and the like. In general, such terms are to be understood as referring to the assembled latch mechanism as if it were installed in a door, where the direction in which the latch head extends is considered the ‘forward’ direction. Thus, considering the latch head extension direction as forward, the door has left and right faces.

In the description that follows, with regard to door structures in which the door latch may be installed, reference may also be made to the ‘inside’, ‘inner’ or ‘internal’ and ‘outside’, ‘outer’ or ‘external’ which are commonly used terms that delineate features that lie to one side or the other of the doorway. It should be appreciated these terms are generally used in a relative sense that does not necessarily imply or import other meanings or features unless clearly stated. Moreover, when considering the door having a forward direction as defined by the latch head extension, the left-hand side may be the ‘inside’ and the right-hand side may be the ‘outside’, or vice versa.

Certain features of the door latch mechanism are similar on both sides of the door when installed, while other features may be different for the inside and outside. For example, in the case of a door latch with a privacy mode mechanism each side of the door may have similar user-operated handle actuators but different access to and engagement with the privacy setting mechanism. For ease of reference, similar features of the embodiments that are provided on each side of the door are designated by a reference numeral followed by a suffix ‘A’ or ‘B’ corresponding to respective sides of the door. It will be appreciated that A or B may arbitrarily correspond to left or right, inside or outside, unless otherwise stated.

An exemplary embodiment of a lock and latch set employing a magnetic latching action and having low-profile user-operable locks and push/pull handles is shown in various views in the accompanying drawings, with functions and features thereof described hereinbelow. This description focusses on two particular aspects, namely: (1) a bolt extension safety catch; and (2) features and functions relating to privacy locking.

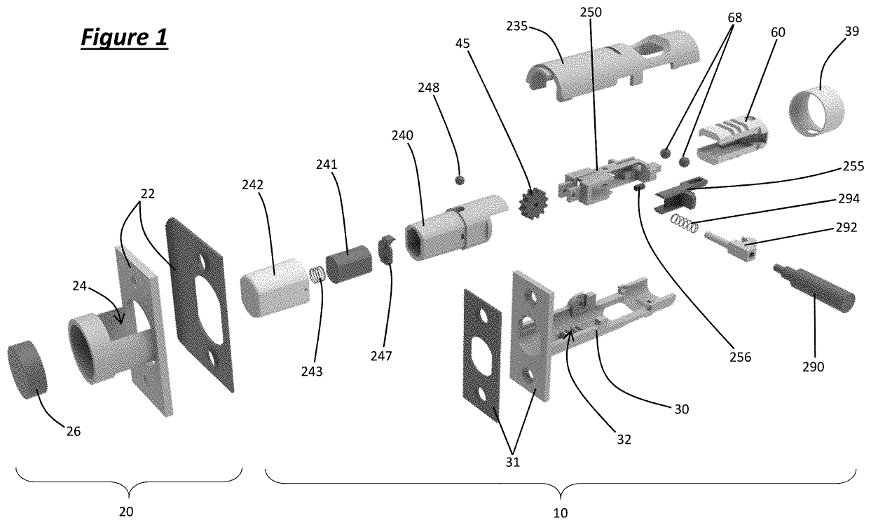

FIG. 1 is an exploded perspective view illustrating the main components of a magnetic door latch according to embodiments of the present disclosure. Components and sub-assemblies such as door handles, lock cylinders, etc. that may form part of a complete magnetic door lock and latch set are not shown in this Figure for improved clarity.

The general structure of the latch and locking mechanism 10 comprises an elongate housing having lower and upper casing components 30 and 235 which, when assembled together, support therein a bolt body 240, bolt carriage 250 and gear shuttle 60, along with associated parts as described herein. The lower casing 30 has a faceplate 31 at its forward end that lies flush with the swinging edge of a door when installed, in conventional manner. Thus, when installed the rest of the housing and components therein lie at least substantially within the door structure, apart from a head portion 242 of the bolt body 240 which selectively protrudes through an aperture in the faceplate 31, as explained below.

The strike 20 is in use installed in a door frame or similar structure, aligned with the latch and locking mechanism 10 in a door conventional manner. The strike 20 has a strike plate 22 surrounding a strike cavity 24. A strike magnet 26 is provided at the end of the strike cavity 26. The bolt head 242 also contains a magnet 241, wherein the magnetic polarities of the bolt head magnet and strike magnet are arranged to attract one another. When the bolt head in use aligns with the strike cavity magnetic forces draw the bolt head magnet toward the strike magnet whereby the bolt is drawn from a retracted position to an engaged position. In the engaged position the head portion 242 of the bolt 240 extends forward of the faceplate 31 and into the strike cavity 24. When the bolt 242 head is engaged in the strike cavity the door in which the latch 100 is installed is held (closed) relative to the corresponding door frame or structure.

### Bolt Extension Safety Catch

As noted above, for reliable operation of the latch the force of attraction between the magnetic components in the strike and the bolt should result in a strong, positive latching action by being sufficiently powerful to easily overcome any frictional and/or opposite bias forces resisting extension of the bolt head. Accordingly, while it might be desirable to generally minimize frictional forces on extension of the bolt head, without due care circumstances of use or misuse of the door could result in the bolt extending prematurely, before the door is closed and the bolt is aligned with the strike plate cavity. For example, consider the circumstances of a door being swung with force from a fully open configuration, whether by deliberate action or something like wind action on the door. Centrifugal forces generated by the rapidly pivoting door could be great enough to cause the bolt to extend from the edge of the door, overcoming any frictional forces, before the door is fully closed. If this were to happen, damage to the latch, door and/or door jamb could result.

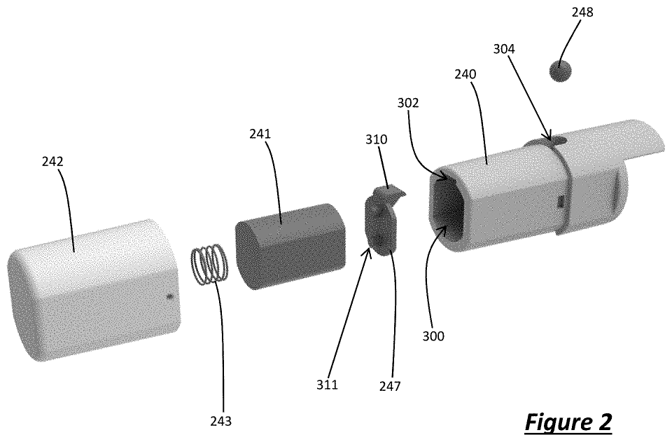

To prevent, or at least substantially reduce the likelihood of, premature extension of the latch bolt before the door is fully closed, a bolt extension safety catch mechanism is provided. An exploded perspective view of the magnetic door latch bolt and components associated with the bolt extension safety catch mechanism is seen in FIG. 2. The safety catch mechanism uses a ball bearing 248 that sits in a ball seat receptacle 304 in the top of the bolt component 240. When the mechanism is assembled, a safety catch plate 247 is attached to the rear end of the bolt magnet 241. The safety catch plate has a rearwardly projecting ball lifter 310, extending marginally above the profile of the magnet 241. As seen in FIG. 2, the bolt 240 has a forward opening bolt magnet cavity 300 with a cross-sectional shape to receive the magnet 241 and safety catch plate 247 while allowing for a small amount of sliding longitudinal movement for purposes described below. When received in the cavity 300 the ball lifter 310 is aligned with a channel 302 in the top of the cavity, the rearward end of the channel 302 opening into the bottom of the ball seat receptacle 304.

The component 242 referred to as the ‘bolt head’ functions as an exterior cover over the bolt head assembly which includes the bolt head body 240 and the bolt magnet 241. The bolt head component 242 has a rearward opening cavity (not seen in FIG. 2) and fits over the forward end of the bolt 240, in use capturing the bolt magnet 241 and safety catch plate 247 in the bolt magnet cavity 300. A compression spring 243 is provided between the front of the magnet 241 and the inner forward end of the bolt head cavity. In the absence of other forces, the spring 243 urges the magnet 241 and plate 247 toward the rear of the cavity 300. When the plate 247 is positioned to the rear of cavity 300 the ball lifter 310 protrudes into the bottom of the ball seat receptacle 304.

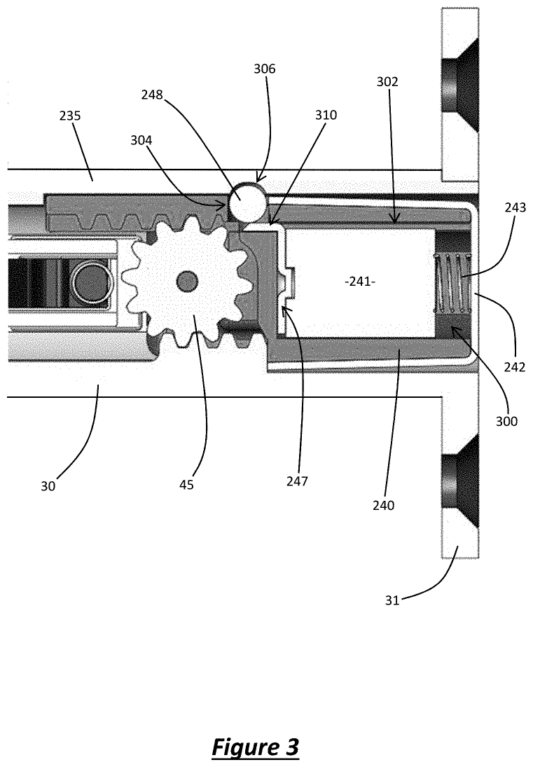

The assembled latch bolt with extension safety catch is shown in vertical longitudinal cross-section in FIG. 3, the bolt being in a retracted condition. As shown, the bolt magnet 241, safety catch plate 247 and spring 243 sit within the bolt cavity 300, and the end of the bolt 240 is in turn encased by the bolt head 242. In the absence of other forces (e.g., from the strike magnet), magnet 241 and plate 247 are urged to the rear (i.e., to the left in FIG. 3) by the spring 243. This forces the ball lifter 310 into the bottom of the ball seat receptacle 304 and underneath the safety catch ball 248, lifting the ball bearing 248 so that its top surface protrudes above the surface of the bolt 240. A ball catch recess 306 is provided in the interior of the upper casing 235, aligned with the position of the safety catch ball 248 when the bolt is in the retracted position. When the latch bolt is retracted as shown in FIG. 3, with the safety catch ball 248 supported on the ball lifter 310 so that it partially protrudes into the ball catch recess 306, the safety catch ball locks the bolt in place and prevents it from extending.

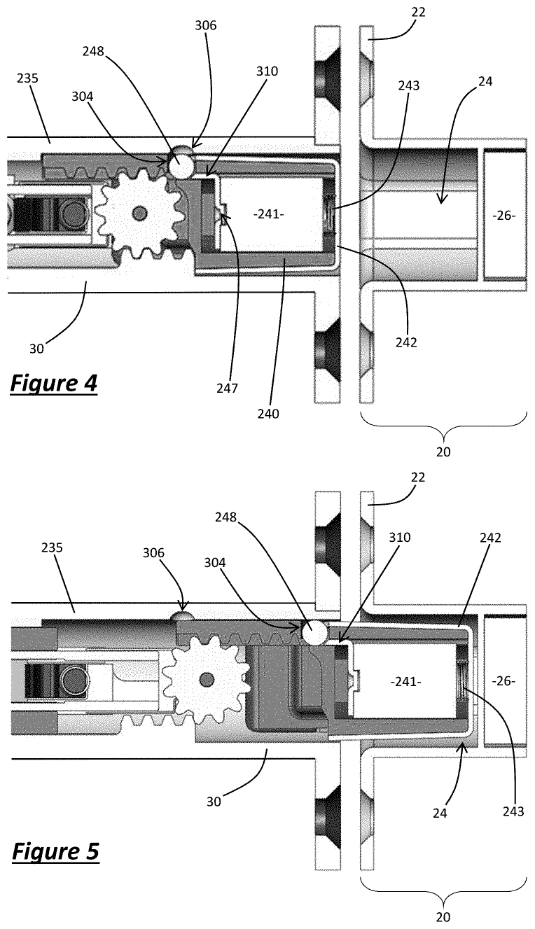

When the bolt head aligns with the strike 20 (as seen in FIG. 4), magnetic attraction between the bolt magnet 241 and the strike magnet 26 causes the bolt magnet to slide forward within the bolt head, compressing the spring 243 and removing the ball lifter 310 from beneath the safety catch ball 248. This action enables the locking ball to disengage from the recess 306 in the upper casing such that the bolt is no longer restricted in extensive movement. Accordingly, the bolt head is able to extend into the strike cavity (FIG. 5), in use locking the door.

When the bolt is retracted through use of the door handle and the door is opened, the safety catch ball 248 reengages the safety catch.

The safety catch mechanism may also operate when the bolt assembly is inverted, for example were the magnetic latch and lock set to be installed upside-down. The depth of the ball catch cavity 306 may be made shallow enough to allow the locking ball to disengage despite gravity encouraging the ball to sit in the recess. In terms of scale, embodiments of the present disclosure may use a safety catch ball having a diameter in the order of 3 mm. Likewise, in embodiments of the present disclosure, the bolt magnet 241 and safety catch plate 247 only need move about 2-3 mm within the bolt head as between the safety catch being engaged and disengaged. In view of the small tolerances, reliable operation of the safety catch is assisted by ensuring proper alignment between the components is maintained. To establish and maintain alignment between the bolt magnet 241 and plate 247, one or more projecting plate alignment formations 311 (FIG. 2) are provided on the forward-facing surface of the plate 247, with complementary detents on the rear of the magnet. Moreover, it has been found that the safety catch plate 247 may be made from magnetically susceptible steel, for example, as the magnetic attraction between the magnet 241 and plate 247 helps keep the two in relative alignment. The aforementioned channel 302 also assists in guiding the ball lifter 310, in use.

It should be appreciated that the safety catch could be disengaged by application of centrifugal force sufficient to shift the bolt magnet 241 and plate 247 forward against the resistance of spring 243. Nevertheless, a magnetic latch employing the safety catch mechanism disclosed herein is advantageous as compared to a latch in which the bolt is held in its retracted position only by frictional forces which apply inconsistent and unpredictable resistance to the bolt extension. There is however a need to balance the stiffness of the spring 243 in order to: (a) retain the locking ball in the ball catch recess of the housing when the door is slammed (generating centrifugal force); and (b) release the locking ball when the latch bolt is aligned with the strike.

Accordingly, the spring stiffness can be selected bearing in mind the mass of the bolt magnet and safety catch plate, and the magnetic forces between the bolt and strike magnets, to make it unfeasible for centrifugal forces to release the safety catch in ordinary use. Moreover, the configuration of the safety catch mechanism disclosed herein requires that centrifugal forces on the bolt magnet would have to fully compress the spring 243 for the catch to disengage and allow the bolt to extend. In contrast, a frictionally held bolt could be caused to overcome just enough friction for the bolt head to only slightly protrude from the edge of the door, but still result in damage.

In terms of magnets, the embodiments described herein employ a magnetised component for both the bolt magnet and the strike magnet, appropriately oriented to attract one another rather than repel. It may be possible for one or other of the bolt magnet and strike magnet to instead be simply magnetically susceptible to the magnet field of the other component. Either way, care should be taken in selecting the materials from which other elements of the latch and lock set are constructed to avoid the magnetic fields interfering in operations. For example, it is preferred that the locking ball 248 be made of a non-magnetic material.

### Privacy Locking

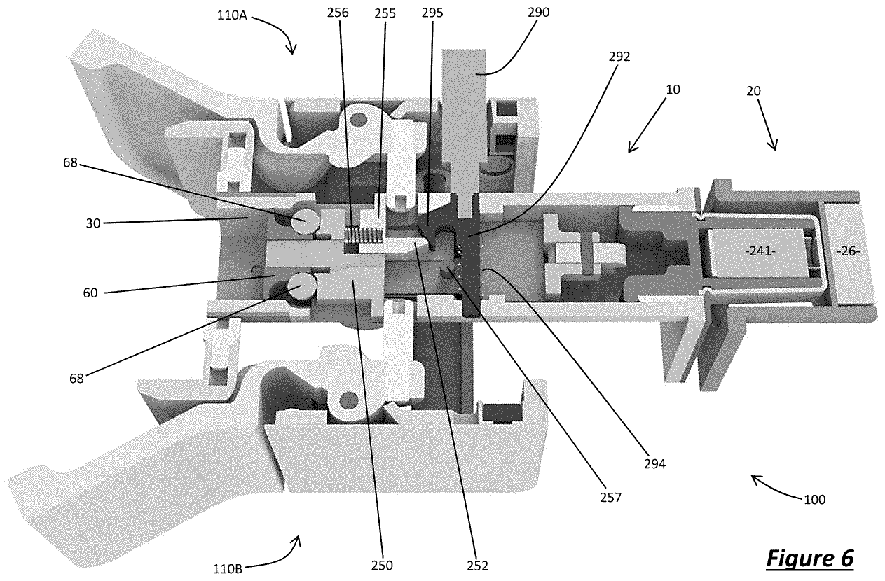

FIGS. 6-9 are overhead perspective views of the latch and lock set seen in central horizontal section, illustrating engagement of the privacy lock mechanism. The privacy locking function enables a user from the inside of the door to activate the privacy lock, without use of a key, and thereby prevent the door being unlatched by way of the outside handle. The privacy locking function can be deactivated by use of the inside handle, or by use of a key in either of the inside or outside lock cylinders. But for the entry lock (privacy) function of the latch 100 the operation of the outside handle assembly 110B to affect the unlatching function could be implemented in the same way as the inside handle 110A. However, to distinguish between the inside and the outside for the purposes of privacy, the actions of the inside and outside actuators are treated differently.

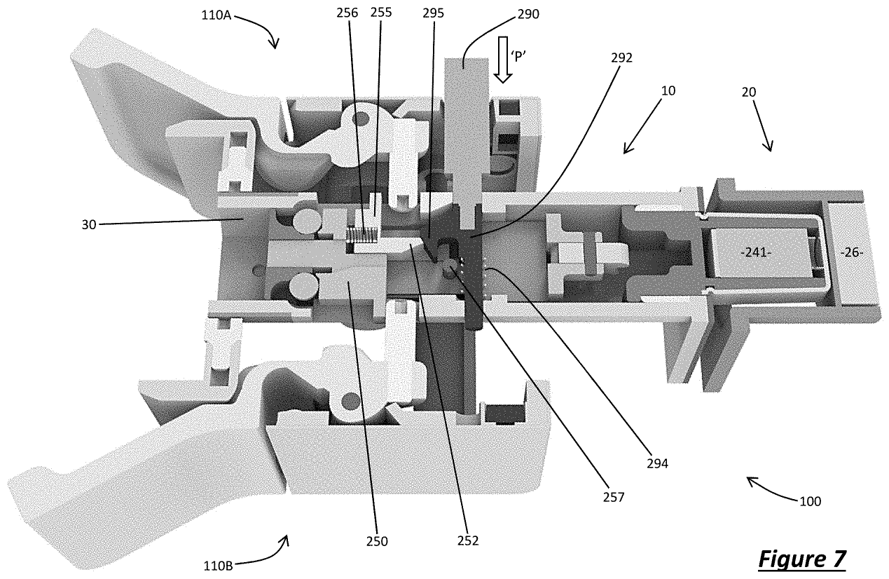

In the latch structure as disclosed in AU2019226304 the outside actuator arm (120B) bears against a surface of the tab shuttle (55) instead of the bolt carriage (50) itself. The tab shuttle is arranged with a degree of forward-rearward movement relative to the bolt carriage for the purposes of the privacy lock operation. When the privacy lock is engaged (as shown in FIGS. 7C and 7D) the tab shuttle is unable to move in the rearward direction by virtue of the shuttle privacy formation being engaged by the hooked end of the privacy engagement projection (95). As a result, the outside handle is unable to perform the unlatching function.

Conversely, in the privacy locking mechanism disclosed herein the tab shuttle component 255 is located to interact with the inside actuator 110A, rather than the outside actuator 110B. Moreover, the hook 295 on the privacy pin inner 292 acts to lock movement of the bolt carriage 250, rather than the tab shuttle.

The enabling mechanism for the privacy locking function includes a privacy push pin 290 that extends through the inside faceplate and cover plate. One end of the privacy push pin 290 is accessible to the user on the inside of the door, and the other end is connected with the privacy pin inner 292 located within the casing of the latch and locking mechanism 10. The privacy push pin 290 and privacy pin inner 292 are supported by the casing for displaceable movement transverse to the direction of movement of the bolt and bolt carriage. In FIG. 6 the privacy pin 290 and privacy pin inner 292 are shown in the inactive position, biased thereto by way of the privacy compression spring 294.

FIG. 6 shows the latch 100 in the latched state wherein the bolt head is extended into the strike cavity, with the privacy function inactive. This enables latching and unlatching as previously described. From this configuration the privacy function is engaged by the user pushing on the privacy push pin 290 as indicated by arrow ‘P’ in FIG. 7.

The privacy pin inner 292 has a rearwardly extending privacy engagement projection 295 that is hook shaped with a sloped end face. The sloped end face of the projection 295 is aligned with a complementary sloped face provided by a privacy formation 252 on the tab shuttle 255. As the privacy pin is pressed inwardly (FIG. 7) the sloped end face of the projection 295 engages with the sloped face on the shuttle privacy formation 252 causing the shuttle 255 to marginally displace in the rearward direction against the compression spring 256, allowing the privacy engagement projection 295 to pass over.

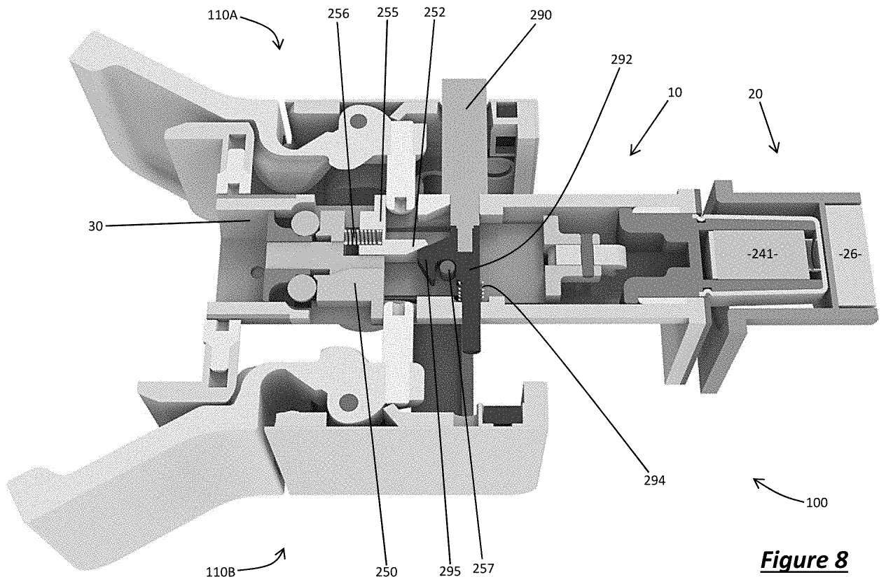

As the privacy push pin 290 is pressed further (against the bias force of spring 294) the privacy engagement projection 295 moves far enough that the shuttle privacy formation 252 latches behind the privacy engagement projection 295, as seen in FIG. 8. While the tab shuttle remains in place the privacy pin is unable to be returned to the disengaged position by force of the spring 294. At this point the privacy lock function is engaged, and the hook portion of the privacy engagement projection 295 is engaged with a carriage privacy formation 257 which restrains movement of the bolt carriage 250.

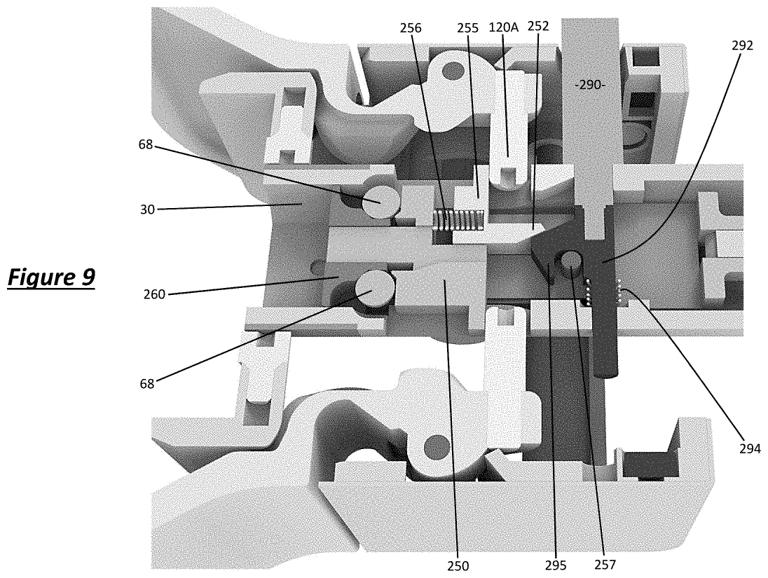

When the privacy lock is engaged as shown in FIGS. 8 and 9, the bolt carriage is unable to move in the rearward direction by virtue of the carriage privacy formation 257 being engaged by the hooked end of the privacy engagement projection 295. As a result, the outside handle is unable to perform the unlatching function.

Ordinarily, deactivation of the entry (privacy) lock may be accomplished by the user operating the inside actuator 110A. Pulling on the handle of the inside actuator causes the actuator arm 120A (FIG. 9) to press rearwardly on the tab shuttle 255. The tab shuttle 255 has a degree of free movement, against the bias of spring 256, relative to the bolt carriage 250. This enables the tab shuttle to displace backward until the shuttle privacy formation 252 is clear of the privacy engagement projection 295. Once the shuttle privacy formation 252 is clear of the privacy engagement projection 295 the privacy pin inner 292 and privacy push pin 290 are able to return to their inactive position under bias force from the privacy spring 294, wherein the carriage privacy formation 257 is no longer restrained by the privacy engagement projection 295 (e.g., as seen in FIG. 6). From this condition either of the inside and outside handles can operate to perform the unlatching function as previously described.

The privacy lock can also be released from the inside or outside by use of a key in the inside or outside lock cylinder, in similar manner as described in AU2019226304.

The present disclosure has been described by way of non-limiting example only and many modifications and variations may be made thereto without departing from the spirit and scope of the present disclosure. It may also be noted that while operational and functional components of the embodiments have been described and illustrated, various fasteners that may be used to secure the components together and to the door and door frame structure have been omitted in the interest of simplicity.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### COMPENDIUM OF REFERENCE NUMERALS

100 magnetic door latch and lock assembly (“the latch”)
10 latch and locking mechanism
20 strike
22 strike plate
24 strike cavity
26 strike magnet
30 lower casing
31 faceplate
32 casing rack
235 upper casing
238 bearing recesses
39 case sheath
240 bolt body
241 bolt magnet
242 bolt head (cover)
243 safety catch spring
247 safety catch plate
248 safety catch ball
300 bolt magnet cavity
302 channel
304 ball seat
306 ball catch cavity
310 ball lifter
311 plate alignment formations
45 pinion gear
250 bolt carriage
255 tab shuttle
256 shuttle spring
257 carriage privacy formation
60 gear shuttle
68 ball bearings
290 privacy push pin
292 privacy pin inner
294 privacy spring
295 privacy engagement projection
296 privacy capture pin
110A, 1106 inside, outside handle assemblies (actuators)

1. A safety catch mechanism for a door latch for a hinged or pivoting door having a latch fixture mounted in or on the door that supports a slideable bolt that is magnetically attracted to a fixed strike so as to effect latching action by extension of the bolt, wherein the safety catch mechanism, while engaged, prevents the bolt from extending, wherein the safety catch mechanism comprises:
a catch member that operatively acts between the moveable bolt and the latch fixture; and
an operating mechanism to operate the catch member responsive to magnetic forces from the fixed strike.

2. The safety catch mechanism of claim 1, wherein the catch member is displaceable from a disengaged position to an engaged position in which the catch member binds together the bolt and a latch fixture against relative longitudinal movement.

3. The safety catch mechanism of claim 2, wherein the catch member includes a ball made from non-magnetic material.

4. The safety catch mechanism of claim 2, wherein the operating mechanism includes a catch actuator having a magnetic component, the catch actuator being longitudinally displaceable within the bolt between engaged and disengaged positions and being spring biased toward the engaged position, and wherein the catch actuator in its engaged position is configured to hold the catch member in its respective engaged position.

5. The safety catch mechanism of claim 4, wherein the catch actuator is displaceable by magnetic attraction with the fixed strike from its engaged position to its disengaged position, thereby releasing the catch member from engagement.

6. The safety catch mechanism of claim 4, wherein the catch member includes a locking ball that is carried by the bolt, and wherein the latch actuator includes a lifting surface that operatively lifts the locking ball into the engaged position.

7. A latch mechanism for a hinged or pivoting door, the latch mechanism comprising:
a housing mountable in or on a door;
a latch slider supported by the housing and moveable between an extended positon and a retracted position;
at least one user operable actuator configured to drive the latch slider from the extended position to the retracted position;
a latch bolt supported by the housing and moveable between an extended positon and a retracted position, the latch bolt coupled to the latch slider, the latch bolt including a bolt head having a magnetic component, wherein the latch bolt is operatively drawn to its extended position by magnetic force when the bolt head in use aligns with a magnetically susceptible strike member mounted on a corresponding door fixture; and
a safety catch mechanism which, while engaged, prevents the bolt from extending, the safety catch mechanism including a catch member that operatively acts between the moveable bolt and the housing, and an operating mechanism configured to operate the catch member responsive to magnetic forces from the strike.

8. A door latch for a hinged or pivoting door, the door latch comprising:
a latch body mountable in or on the door, and supporting a latching mechanism with a slideable bolt that is magnetically attracted to a fixed strike so as to effect latching action by extension of the bolt:
a latch slider assembly coupled to move with the latch bolt;
first and second actuators disposable to opposite sides of the door, each of the first and second actuators having a lever arm arranged to act upon the latch slider assembly to effect withdrawal of the latch bolt from its extended position to a retracted position upon operation by a user;
wherein the latch slider assembly includes a bolt carriage and a carriage shuttle that is moveable with the bolt carriage and arranged to permit relative displacement against a spring bias, and wherein the first lever arm is arranged to act upon a surface of the carriage shuttle and the second lever arm is arranged to act upon a surface of the bolt carriage; and
an entry lock mode mechanism having a privacy engagement member moveable between a first position and a second position, wherein the privacy engagement member when in the second position engages with the bolt carriage to prevent displacement of the latch slider assembly by the second actuator.

9. The latch of claim 8, wherein the entry lock mode selection mechanism includes a user operable privacy pin located with the first actuator and coupled to the privacy engagement member to enable movement of the privacy engagement member between the first and second positions.

10. The latch of claim 8, wherein the carriage shuttle provides a latching action with the privacy engagement member to hold the privacy engagement member in the second position.

11. The latch of claim 10, wherein the latching action of the carriage shuttle on the privacy engagement member can be released by operation of the first actuator lever arm on the carriage shuttle.
